(19) United States
(12) Patent Application Publication
(10) Pub. No.: US 2025/0140133 A1
(43) Pub. Date: May 1, 2025

(54) SHOULDER JOINT AND BREAST WITH AXILLA REGION FOR PATIENT SIMULATORS

(71) Applicant: GAUMARD SCIENTIFIC COMPANY, INC., Miami, FL (US)

(72) Inventors: Alfredo HERNANDEZ, Miami, FL (US); Siobhain LOWE, Miami, FL (US)

(21) Appl. No.: 18/933,480

(22) Filed: Oct. 31, 2024

Related U.S. Application Data
(60) Provisional application No. 63/594,773, filed on Oct. 31, 2023.

(51) Int. Cl. G09B 23/34

(52) U.S. Cl. CPC G09B 23/34

(57) ABSTRACT

Systems, apparatuses, and methods are provided for patient simulators and assemblies for patient simulators. Patient simulators may include shoulder assemblies, breast assemblies, and axilla assemblies. A shoulder assembly may be configured to control positioning and orientation of a simulated arm of a patient simulator. A shoulder assembly may include a first portion connected to a simulated torso of the patient simulator and a second portion. The first portion may include a mechanical joint configured to rotate around a first axis and a second axis. A breast and axilla assembly may include an axilla portion, a breast portion, and one or more simulated masses. The breast portion may include an outer breast portion and an inner breast portion. The one or more simulated masses may be disposed within the inner breast portion or the axilla portion.

### CROSS-REFERENCE TO RELATED APPLICATIONS

The present application claims the benefit of the filing date, and priority to, U.S. Provisional Application No. 63/594,773 filed Oct. 31, 2023, the disclosure of which is hereby incorporated herein by reference.

### INTRODUCTION

The present disclosure relates generally to patient simulators. While it is desirable to train medical personnel in patient care protocols before allowing contact with real patients, textbooks and flash cards lack the important benefits to students that can be attained from hands-on practice. On the other hand, allowing inexperienced students to perform medical procedures on actual patients that would allow for the hands-on practice cannot be considered a viable alternative because of the inherent risk to the patient. Because of these factors patient care education has often been taught using medical instruments to perform patient care activity on a simulator, such as a manikin. Examples of such simulators include those disclosed in U.S. patent application Ser. No. 11/952,559 (Publication No. 20080138778), U.S. patent application Ser. No. 11/952,606 (Publication No. 20080131855), U.S. patent application Ser. No. 11/952,636 (Publication No. 20080138779), U.S. patent application Ser. No. 11/952,669 (Publication No. 20090148822), U.S. patent application Ser. No. 11/952,698 (Publication No. 20080138780), U.S. Pat. Nos. 7,114,954, 6,758,676, 6,503,087, 6,527,558, 6,443,735, 6,193,519, and 5,853,292, each herein incorporated by reference in its entirety.

While these simulators have been adequate in many respects, they have not been adequate in all respects. Therefore, what is needed is an interactive education system for use in conducting patient care training sessions that is even more realistic and/or includes additional simulated features.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The present disclosure describes shoulder joint and breast assemblies capable of mimicking various patient positions required during medical examinations. In some aspects, a shoulder joint assembly has sufficient articulations to allow various patient positions within the same patient simulator, including those required for breast examination. Additionally, breast assemblies may include an axilla region. In some aspects, materials are described for internal tissue in breast assemblies which allows for palpation of the breasts and axilla region. In some aspects, masses may be included in the internal tissue of the breast assembly to mimic various masses, including cancerous and benign tissue, which may be detectable through palpation of the breast and axilla regions of the patient simulator. In addition to being detectable by palpation, the various masses may be imaged using ultrasound or other scanning and imaging modalities.

In one general aspect, the present disclosure is directed to a shoulder assembly for a patient simulator. The shoulder assembly also includes a first portion connected to a simulated torso of the patient simulator. The shoulder assembly also includes a second portion, where the first portion includes a mechanical joint. The shoulder assembly also includes where the mechanical joint is configured to rotate around a first axis and a second axis.

In one general aspect, the present disclosure is directed to a patient simulator. The patient simulator also includes a simulated torso; and a first simulated arm, where the first simulated arm includes a shoulder assembly configured to control positioning and orientation of the first simulated arm, where the shoulder assembly includes: a first portion connected to a simulated torso of the patient simulator; and a second portion connected to the first portion, where the first portion includes a mechanical joint. The patient simulator also includes where the mechanical joint is configured to rotate around a first axis and a second axis.

In one general aspect, the present disclosure is directed to a method for assembling a patient simulator. The method also includes connecting a first portion of a shoulder assembly within a simulated arm to a simulated torso of the patient simulator, where the shoulder assembly is configured to control positioning and orientation of the simulated arm and includes: the first portion; and a second portion connected to the first portion, where the first portion includes a mechanical joint. The method also includes where the mechanical joint is configured to rotate around a first axis and a second axis.

In one general aspect, the present disclosure is directed to a breast and axilla assembly for a patient simulator. The breast also includes an axilla portion; a breast portion, where the breast portion includes an outer breast portion and an inner breast portion; and one or more simulated masses disposed within the inner breast portion or the axilla portion such that the one or more simulated masses are embedded in simulated breast tissue filling the inner breast portion.

In one general aspect, the present disclosure is directed to a patient simulator. The patient simulator also includes a simulated torso; a breast and axilla assembly connected to the simulated torso, including: an axilla portion; a breast portion, where the breast portion includes an outer breast portion and an inner breast portion; and one or more simulated masses disposed within the inner breast portion or the axilla portion such that the one or more simulated masses are embedded in simulated breast tissue filling the inner breast portion.

In one general aspect, the present disclosure is directed to a method for assembling a patient simulator. The method also includes attaching a breast and axilla assembly to a simulated torso of a patient simulator. The method also includes where the breast and axilla assembly includes: an axilla portion; a breast portion, where the breast portion includes an outer breast portion and an inner breast portion; and one or more simulated masses disposed within the inner breast portion or the axilla portion such that the one or more simulated masses are embedded in simulated breast tissue filling the inner breast portion.

Other aspects, features, and embodiments of the present invention will become apparent to those of ordinary skill in the art, upon reviewing the following description of specific, exemplary instances of the present invention in conjunction with the accompanying figures. While features of the present invention may be discussed relative to certain examples and figures below, all aspects of the present invention can include one or more of the advantageous features discussed herein. In other words, while one or more arrangements may be discussed as having certain advantageous features, one or more of such features may also be used in accordance with the various aspects and examples of the invention discussed herein. In similar fashion, while exemplary aspects may be discussed below in the context of a device, a system, or a method, it should be understood that such exemplary aspects can be implemented in various devices, systems, and methods.

### BRIEF DESCRIPTION OF THE DRAWINGS

Other features and advantages of the present disclosure will become apparent in the following detailed description of illustrative embodiments with reference to the accompanying of drawings, of which:

FIG. 1 is a perspective view of a portion of a patient simulator, according to one or more aspects of the present disclosure.

FIG. 2 is a partial exploded view of a breast and shoulder joint assembly of a patient simulator, according to one or more aspects of the present disclosure.

FIG. 3 is a partial exploded perspective view of a should joint assembly and torso of patient simulator, according to one or more aspects of the present disclosure.

FIG. 4 is a perspective view of a shoulder joint assembly of a patient simulator, according to one or more aspects of the present disclosure.

FIG. 5 is an exploded view of the shoulder joint assembly of FIG. 4, according to one or more aspects of the present disclosure.

FIG. 6 is a first perspective view of a breast assembly with simulated masses, according to one of more aspects of the present disclosure.

FIG. 7 is a second perspective view of the breast assembly with simulated masses of FIG. 6, according to one or more aspects of the present disclosure.

FIG. 8 is a first perspective view of a breast assembly with simulated masses, according to one of more aspects of the present disclosure.

FIG. 9 is a second perspective view of the breast assembly with simulated masses of FIG. 8, according to one or more aspects of the present disclosure.

FIG. 10 is a first perspective view of a breast assembly with simulated masses, according to one of more aspects of the present disclosure.

FIG. 11 is a second perspective view of the breast assembly with simulated masses of FIG. 10, according to one or more aspects of the present disclosure.

FIG. 12 is a first perspective view of a breast assembly with simulated masses, according to one of more aspects of the present disclosure.

FIG. 13 is a second perspective view of the breast assembly with simulated masses of FIG. 12, according to one or more aspects of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the disclosure is intended. Any alterations and further modifications in the described devices, instruments, methods, and any further application of the principles of the disclosure as described herein are contemplated as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately. For simplicity, in some instances the same reference numbers are used throughout the drawings to refer to the same or like parts.

Generally, the present disclosure describes shoulder joint and breast assemblies capable of mimicking various patient positions required during medical examinations. For example, examination of a patient's breast may require a patient to place their hand behind their head. The shoulder joint assembly described herein has sufficient articulations to allow various patient positions within the same patient simulator, including those required for breast examination. Additionally, breast assemblies are described that include the axilla region. The axilla region contains many lymph nodes that may become cancerous. Examination of this region may require a shoulder articulation to place the patient's hand behind their head. Furthermore, materials are described for the internal tissue in breast assemblies to allow for palpation of the breasts and axilla region. Masses may be included in the internal tissue of the breast assembly to mimic various masses, including cancerous and benign tissue, that may be detectable through palpation of the breast and axilla regions of the patient simulator. In addition to being detectable by palpation, the various masses may be imaged using ultrasound or other scanning and imaging modalities. Because patient evaluation often requires more than mere visual inspection, simulators with appropriate materials are necessary to facilitate training through realistic examinations.

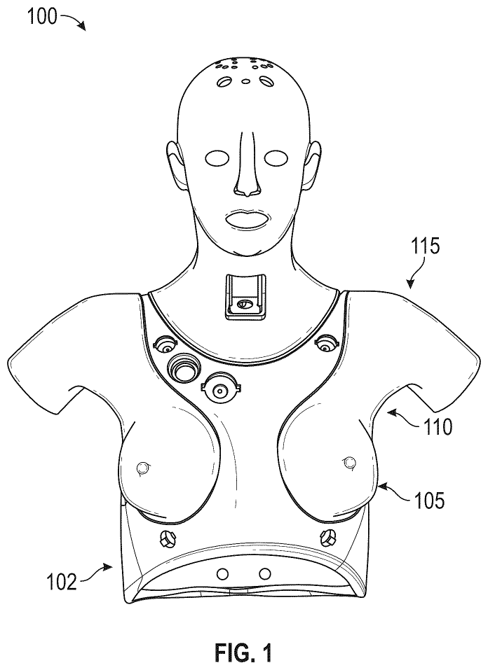

Referring to FIG. 1, shown therein is perspective view of a portion of a patient simulator, according to one or more aspects of the present disclosure. The patient simulator 100 may include a simulated body portion 102. In some instances, the simulated body portion 102 may include a torso, extremities (e.g., arms (or portions thereof, including shoulders), hands, legs (or portions thereof), feet), a neck, and/or a head, up to and including a full body manikin. In some instances, the simulated body portion 102 may vary in size, representing different stages of human development and/or age.

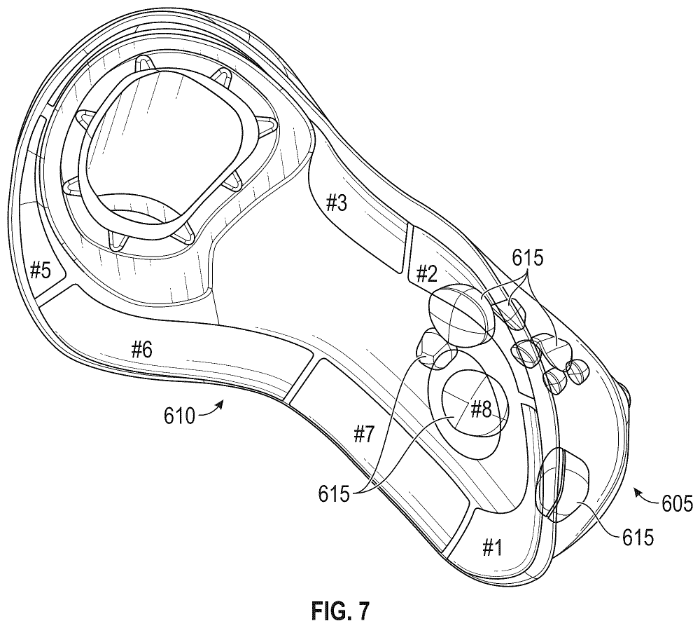

The patient simulator 100 may include a breast assembly 105 and axilla assembly 110. In some aspects, the breast assembly 105 and axilla assembly 110 comprise a single assembly. The internal tissue of the breast assembly 105 may be made of a blend of silicone and oil. The relative composition between silicone and oil is chosen to create a realistic touch experience when a user palpates the breast assembly 105 and axilla assembly 110. In some aspects, internal tissue of the breast assembly 105 may comprise between 49%-59% of 5-20 durometer platinum cured silicone and 51%-41% silicone oil. For example, internal tissue may comprise 54% of 10 durometer platinum cured silicone and 46% silicone oil. In some aspects, the axilla assembly includes internal tissue composed of the same or similar material as breast assembly 105. The breast assembly 105 and axilla assembly 110 may be removably attached to the simulated body portion 102 using hook-and-loop fasteners as well as other means of fastening. Sections of hook-and-loop fastener may be disposed at the numbered locations (e.g., “#1”, . . . , “#8” on the backside of the assemblies, depicted in FIGS. 7, 9, 11, 13. Similar descriptions apply to both the right breast and axilla assemblies as for left breast assembly 105 and axilla assembly 110 and right breast and axilla assemblies. For sake of discussion, descriptions are of the left breast and axilla assemblies, but equally apply to the right-side equivalent assemblies.

The patient simulator may include a shoulder assembly 115. In some aspects, the shoulder assembly 115 is capable of articulated motion. The shoulder assembly 115 may have 1, 2, or 3 degrees of freedom. In some aspects, shoulder assembly 115 allows an arm of a patient simulator to be placed behind the head of the patient simulator. In some aspects, a simulated arm, and the shoulder assembly 115, may be moved as part of a breast examination. For sake of discussion, descriptions are of the left shoulder assembly 115, but equally apply to a right shoulder assembly.

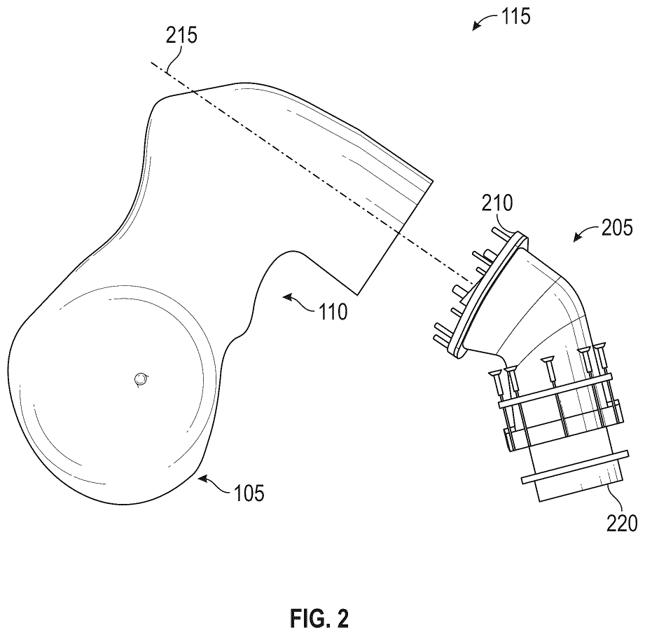

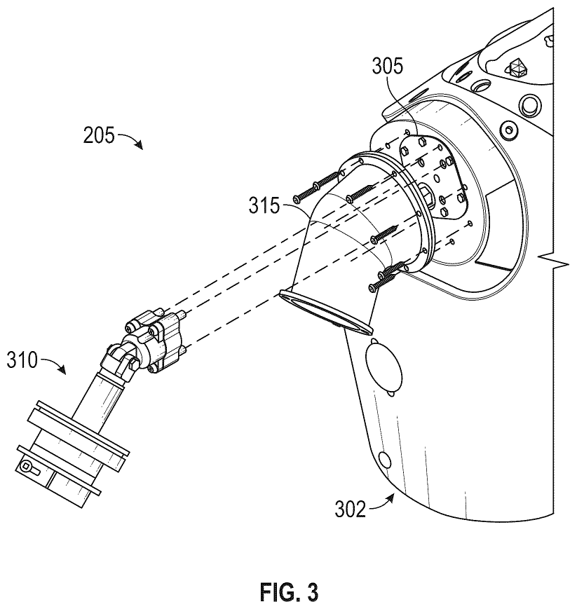

Referring to FIG. 2, shown therein is a partially exploded view of a breast and shoulder joint assembly of a patient simulator, according to one or more aspects of the present disclosure. FIG. 2 depicts breast assembly 105, axilla assembly 110, and shoulder assembly 115. Shoulder assembly 115 is exploded to reveal the shoulder joint assembly 205. In some aspects, the shoulder joint assembly is connected to a shoulder plate (described below in relation to FIG. 3) attached to the simulated body portion 102. Shoulder joint assembly 205 is attached to the shoulder plate at the torso interface 210 in the direction of the axis 215. In some aspects, the shoulder joint assembly 205 may connect to an arm of a patient simulator at arm interface 220. While breast assembly 105, axilla assembly 110, shoulder assembly 115 correspond configurations for a left side of a patient simulator, it should be appreciated that configurations for a right side of a patient simulator are also contemplated.

In some aspects, the shoulder joint assembly 205 is configured to move about the torso interface 210. Furthermore, the portion of the shoulder assembly 115 formed monolithically with the breast assembly 105 and axilla assembly 110 is comprised of material that allows said portion move in conformity with the movement of the shoulder joint assembly 205.

Referring to FIG. 3, shown therein is a partial exploded perspective view of a shoulder joint assembly and torso of patient simulator, according to one or more aspects of the present disclosure. FIG. 3 includes a torso 302, shoulder joint assembly 205, a shoulder plate 305, as viewed from a position behind a patient simulator 100. The shoulder joint assembly 205 is partially exploded to reveal a mechanical joint assembly 310. In some instances, the mechanical joint assembly 310 may be contained, at least partially, within an internal sleeve 315. The internal sleeve 315 may protect the mechanical joint assembly 310 by preventing debris from the surrounding environment from reaching components of the mechanical joint assembly 310. In some aspects, the shoulder assembly is connected to the simulated torso first and then the external sleeve is slipped over the shoulder assembly and connected to the simulated torso.

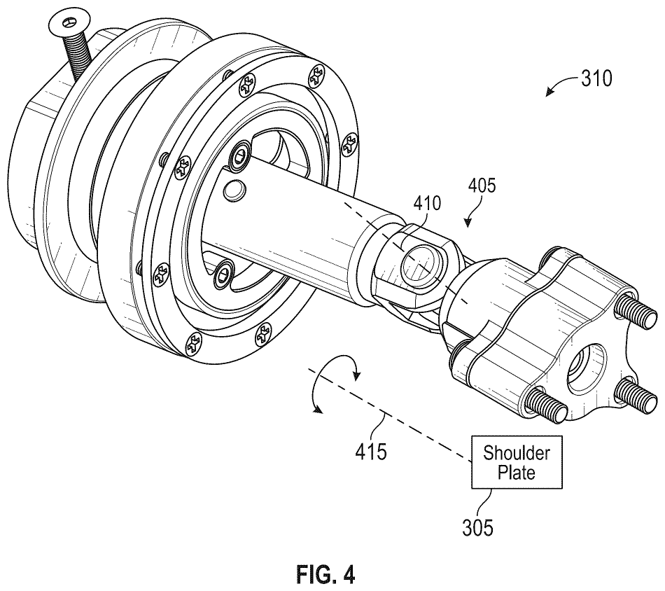

Referring to FIG. 4, shown therein is a perspective view of a shoulder joint assembly of a patient simulator, according to one or more aspects of the present disclosure. FIG. 4 depicts the mechanical joint assembly 310 of shoulder joint assembly 205. The mechanical joint assembly 310 may include a joint 405. Joint 405 facilitates the articulation of the shoulder joint assembly 205 and thereby the shoulder assembly 115. The joint 405 may have one or more degrees of freedom. In some instances, joint 405 may facilitate rotations of an arm about the joint 405, i.e., about an axis 410. Axis 410 may be approximately parallel to the plane of the shoulder plate 305. Such rotations tend to move the arm closer or further away from the body of a patient simulator. In some instances, joint 405 may facilitate rotations about an axis 415 which is perpendicular to the plane of the shoulder plate 305 of FIG. 3. For example, if the arm is stretched out from the side of the patient simulator at 90 degrees, then rotations around axis 415 are approximately rotations about the length of the arm. Such a rotation about an axis 415 may be referred to as internal/external rotations when describing motion of the human shoulder joint. In some aspects, axis 410 and axis 415 may be perpendicular to each other.

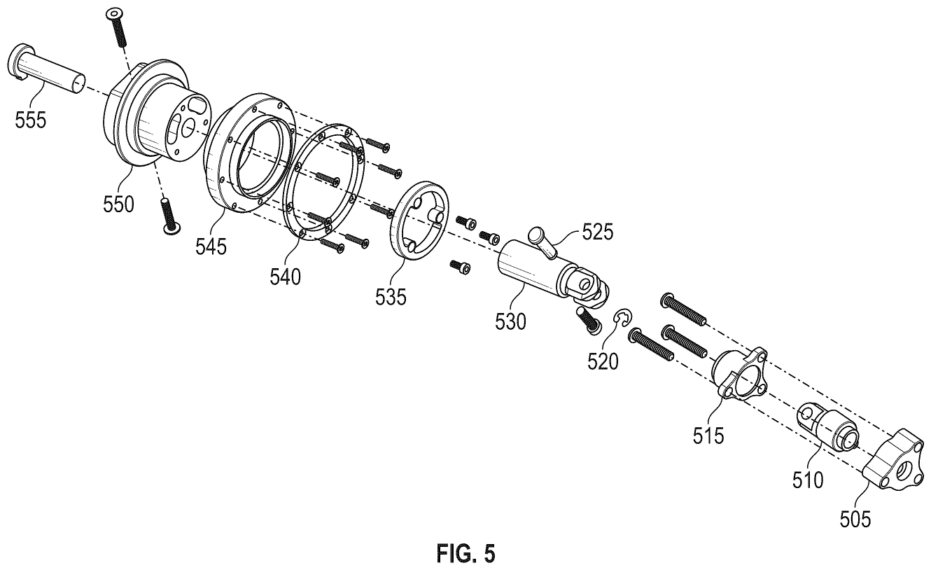

Referring to FIG. 5, shown therein is an exploded view of the shoulder joint assembly of FIG. 4, according to one or more aspects of the present disclosure. FIG. 5 includes shoulder articulation support stopper 505, joint shaft 510, shoulder articulation support 515, retaining ring 520, pin 525, upper arm bar 530, shoulder sleeve bearing stopper 535, first shoulder sleeve bearing 540, second shoulder sleeve bearing 545, upper arm cap 550, upper arm cap stopper 555, as well as various screws and other fastening means for physically coupling the various components. In the description that follows, proximal refers to one component being closer to the shoulder plate than another while distal refers to one component being farther from the shoulder plate than another. Some components may only be partially proximal or distal relative to another.

In some instances, shoulder articulation support stopper 505 is fastened to a shoulder plate 305. At least a portion of joint shaft 510 is located distally to the shoulder articulation support stopper 505. Joint shaft 510 may lay concentrically interior to the shoulder articulation support 515. Shoulder articulation support 515 is located distally to the shoulder articulation support stopper 505. Shoulder articulation support 515 is fastened to the shoulder articulation support stopper 505. Shoulder articulation support 515 and shoulder articulation support stopper 505 hold joint shaft 510 fixed in the proximal-distal direction through contact forces and/or frictional forces. In some instances, joint shaft 510 may rotate around the axis defined by the proximal-distal direction. Joint shaft 510 is physically coupled to the upper arm bar 530 via the pin 525 and retaining ring 520. The upper arm bar 530 is located distally to the joint shaft 510. In some instances, the pin 525 may be a clovis pin. Joint shaft 510 is rigidly fastened to upper arm cap stopper 555. Concentrically surrounding the fastened joint shaft 510 and upper arm cap stopper 555 are the shoulder sleeve bearing stopper 535, first shoulder sleeve bearing 540, second shoulder sleeve bearing 545, and upper arm cap 550. The shoulder sleeve bearing stopper 535 is located proximally to the upper arm cap 550. The shoulder sleeve bearing stopper 535 is fastened to the upper arm cap 550. First shoulder sleeve bearing 540 is located proximally to the second shoulder sleeve bearing 545. First shoulder sleeve bearing 540 is fastened to second shoulder sleeve bearing 545. The first shoulder sleeve bearing 540 and second shoulder sleeve bearing 545 may also jointly fasten the internal sleeve 315.

In some aspects, one or more components located proximally to a second one or more components may be referred to as a first portion of a mechanical joint assembly 310, while the second one or more components may be referred to as a second portion of a mechanical joint assembly 310. In some instances, the mechanical joint assembly 310 may be referred simply as a shoulder assembly.

In some instances, joint shaft 510, upper arm bar 530, retaining ring, and pin 525 comprise the joint 405, as described in FIG. 4, about which an arm may move relative to the torso in a patient simulator.

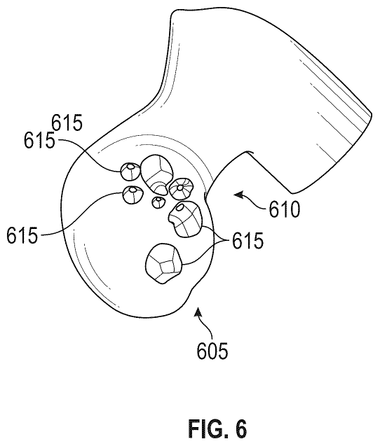

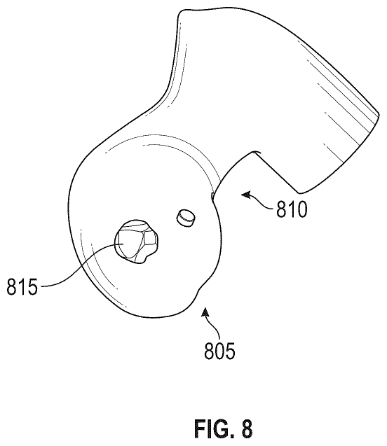

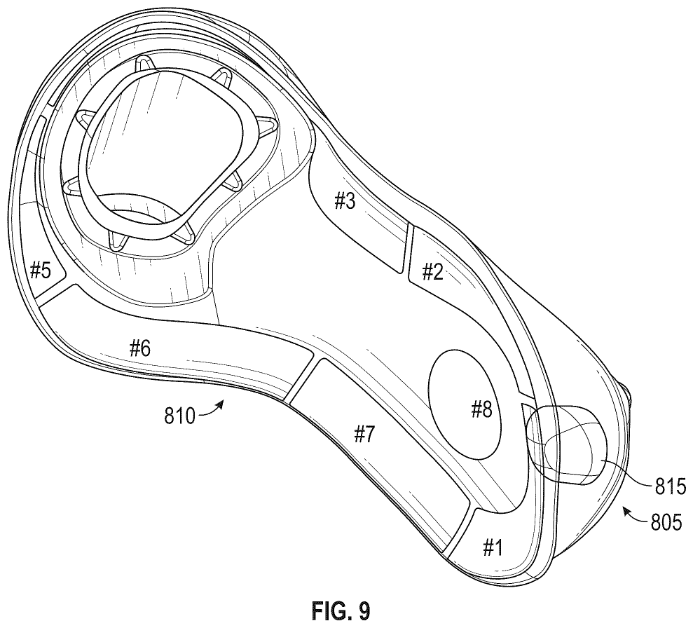

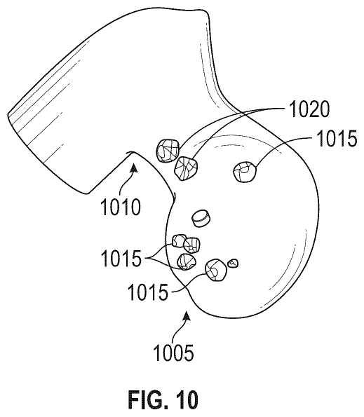

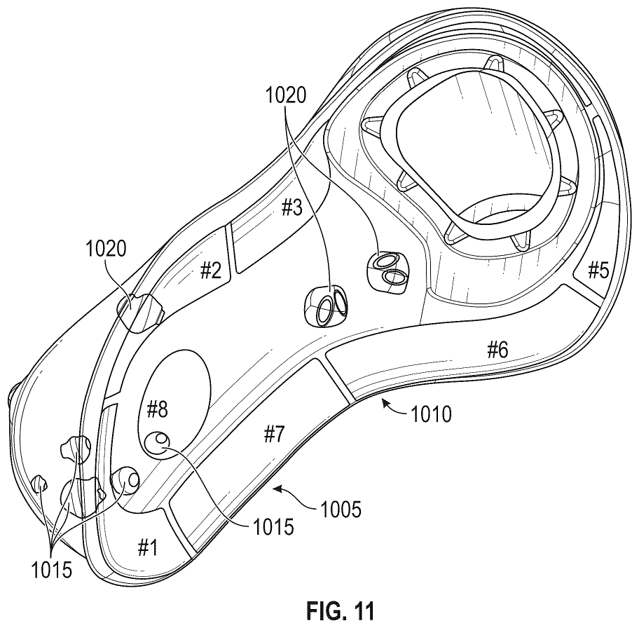

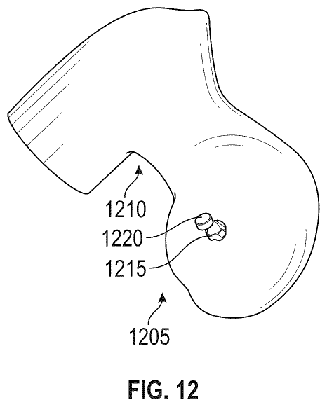

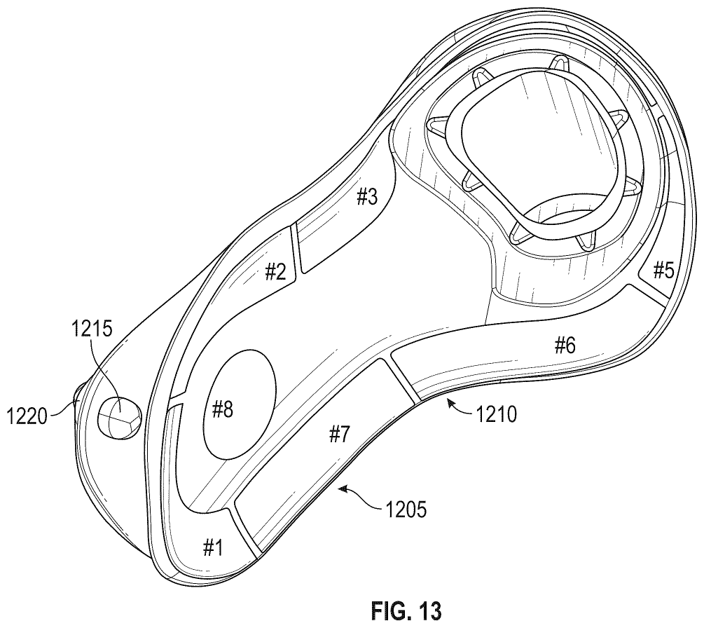

Referring now to FIGS. 6-13, shown therein are multiple configurations breast and axilla assemblies with various masses. The masses may mimic fibrocystic nodes, carcinoma in a milk duct, fibroadenomas, benign mass, giant sarcoma (or giant mammary myxoma), scirrhous carcinoma, etc. Healthy breast tissue may correspond to the lack of masses within a breast and axilla assembly. In this regard, FIG. 6 is a first perspective view of a breast assembly with simulated masses. FIG. 7 is a second perspective view of the breast assembly with simulated masses of FIG. 6. FIG. 8 is a first perspective view of a breast assembly with simulated masses. FIG. 9 is a second perspective view of the breast assembly with simulated masses of FIG. 8. FIG. 10 is a first perspective view of a breast assembly with simulated masses. FIG. 11 is a second perspective view of the breast assembly with simulated masses of FIG. 10. FIG. 12 is a first perspective view of a breast assembly with simulated masses. FIG. 13 is a second perspective view of the breast assembly with simulated masses of FIG. 12. Though simulated masses may be depicted in the internal tissue of a right or left breast assembly and axilla assembly, it should be appreciated that simulated masses may included in left and/or right breast assemblies and/or axilla assemblies. During a training examination one or more breast and axilla assemblies, which are removably couplable to a simulated torso, may be switched out to allow a user to palpate or image different types of masses. Various different mass sizes and configurations are described below. In some aspects, simulated masses may be composed of 5-20A durometer platinum cured silicone. For example, a simulated mass be composed of 10A durometer platinum cured silicone.

Referring to FIG. 6, shown therein is a first perspective view of a breast assembly with simulated masses, according to one or more aspects of the present disclosure. FIG. 6 includes breast assembly 605, axilla assembly 610, and simulated masses 615. Simulated masses 615 may represent palpable tumors such as giant sarcoma. The simulated masses 615 may be palpated at various areas of the breast assembly 605 and axilla assembly 610. The simulated masses 615 may vary in size from 5 mm to 30 mm with other sizes possible depending on the training requirements for examinations.

Referring to FIG. 7, shown therein is a second perspective view of the breast assembly with simulated masses of FIG. 6, according to one or more aspects of the present disclosure. FIG. 7 depicts a view from the back side of the breast assembly 605 and axilla assembly 610, which, when attached to the torso of a patient simulator would not be visible or palpable.

Referring to FIG. 8, shown therein is a first perspective view of a breast assembly with simulated masses, according to one or more aspects of the present disclosure. FIG. 8 includes breast assembly 805, axilla assembly 810, and simulated mass 815. Simulated mass 815 may represent palpable scirrhus carcinoma, a malignant tumor. When palpated, simulated mass 815 would not appear to have well-defined borders, nor would it be movable within the breast assembly 805. The simulated mass 815 may be palpated at various areas of the breast assembly 805 and axilla assembly 810. The simulated masses 815 may vary in size from 25 mm to 35 mm with other sizes possible depending on the training requirements for examinations.

Referring to FIG. 9, shown therein is a second perspective view of the breast assembly with simulated masses of FIG. 8, according to one or more aspects of the present disclosure. FIG. 9 depicts a view from the back side of the breast assembly 805 and axilla assembly 810, which, when attached to the torso of a patient simulator would not be visible or palpable.

Referring to FIG. 10, shown therein is a first perspective view of a breast assembly with simulated masses, according to one or more aspects of the present disclosure. FIG. 10 includes breast assembly 1005, axilla assembly 1010, simulated breast masses 1015, and simulated axilla masses 1020. Simulated breast masses 1015 may be located in the internal tissue of breast assembly 1005 and may represent fibrocystic nodes. Simulated axilla masses 1020 may be located in the internal tissue of the axilla assembly 1010 and may present malignant tumors. The simulated masses 1015, 1020 may be palpated at various areas of the breast assembly 805 and axilla assembly 810. The simulated masses 1015, 1020 may vary in size from 5 mm to 25 mm with other sizes possible depending on the training requirements for examinations.

Referring to FIG. 11, shown therein is a second perspective view of the breast assembly with simulated masses of FIG. 10, according to one or more aspects of the present disclosure. FIG. 11 depicts a view from the back side of the breast assembly 1005 and axilla assembly 1010, which, when attached to the torso of a patient simulator would not be visible or palpable.

Referring to FIG. 12, shown therein is a first perspective view of a breast assembly with simulated masses, according to one or more aspects of the present disclosure. FIG. 12 includes breast assembly 1205, axilla assembly 1210, and simulated mass 1215. Simulated mass 1215 may represent a palpable carcinoma in a milk duct. The simulated mass 1215 may be palpated at various areas of the breast assembly 1205. Furthermore, the nipple 1220 of the breast assembly 1205 may be retracted. The simulated mass 1215 may vary in size from 15 mm to 25 mm with other sizes possible depending on the training requirements for examinations.

Referring to FIG. 13, shown therein is a second perspective view of the breast assembly with simulated masses of FIG. 12, according to one or more aspects of the present disclosure. FIG. 13 depicts a view from the back side of the breast assembly 1205 and axilla assembly 1210, which, when attached to the torso of a patient simulator would not be visible or palpable.

The following includes aspects of the present disclosure to provide an understanding of the discussed technology. This following is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure.

In one general aspect, the present disclosure is directed to a shoulder assembly for a patient simulator. The shoulder assembly also includes a first portion connected to a simulated torso of the patient simulator. The shoulder assembly also includes a second portion, where the first portion includes a mechanical joint. The shoulder assembly also includes where the mechanical joint is configured to rotate around a first axis and a second axis.

In some aspects, implementations may include one or more of the following features. The shoulder assembly where the shoulder assembly is actuatable at the mechanical joint to allow the simulated arm of the patient simulator to be configured for examination by a user. The examination is a breast or axilla examination. The shoulder assembly may include: an outer sleeve surrounding at least the first portion and connected to the simulated torso. The first axis and the second axis are perpendicular to each other. The shoulder assembly is sized for an adult patient simulator. The shoulder assembly is sized for a child patient simulator.

In one general aspect, the present disclosure is directed to a patient simulator. The patient simulator also includes a simulated torso; and a first simulated arm, where the first simulated arm includes a shoulder assembly configured to control positioning and orientation of the first simulated arm, where the shoulder assembly includes: a first portion connected to a simulated torso of the patient simulator; and a second portion connected to the first portion, where the first portion includes a mechanical joint. The patient simulator also includes where the mechanical joint is configured to rotate around a first axis and a second axis.

In some aspects, implementations may include one or more of the following features. The patient simulator where the shoulder assembly is actuatable at the mechanical joint to allow the first simulated arm of the patient simulator to be configured for examination by a user. The examination is a breast or axilla examination. The patient simulator may include: an outer sleeve surrounding at least the first portion and connected to the simulated torso. The first axis and the second axis are perpendicular to each other. The shoulder assembly is sized for an adult patient simulator. The second simulated arm includes a second shoulder assembly configured to control positioning and orientation of the second simulated arm, where the second shoulder assembly includes: a third portion connected to the simulated torso of the patient simulator on a side opposite the first portion; and a fourth portion, where the third portion includes a second mechanical joint, where the mechanical joint is configured to rotate around a third axis and a fourth axis, and where the first simulated arm and second simulated arm are configured for bilateral articulation.

In one general aspect, the present disclosure is directed to a method for assembling a patient simulator. The method also includes connecting a first portion of a shoulder assembly within a simulated arm to a simulated torso of the patient simulator, where the shoulder assembly is configured to control positioning and orientation of the simulated arm and includes: the first portion; and a second portion connected to the first portion, where the first portion includes a mechanical joint. The method also includes where the mechanical joint is configured to rotate around a first axis and a second axis.

In some aspects, implementations may include one or more of the following features. The method where the shoulder assembly is actuatable at the mechanical joint to allow the simulated arm of the patient simulator to be configured for examination by a user. The examination is a breast or axilla examination. The outer sleeve surrounds at least the first portion. The first axis and the second axis are perpendicular to each other. The shoulder assembly is sized for an adult patient simulator.

In one general aspect, the present disclosure is directed to a breast and axilla assembly for a patient simulator. The breast also includes an axilla portion; a breast portion, where the breast portion includes an outer breast portion and an inner breast portion; and one or more simulated masses disposed within the inner breast portion or the axilla portion such that the one or more simulated masses are embedded in simulated breast tissue filling the inner breast portion.

In some aspects, implementations may include one or more of the following features. The breast and axilla assembly where the one or more simulated masses are palpable by a user during a simulated breast examination. The one or more simulated masses are 5-30 mm wide. The simulated breast tissue is composed of a mixture of silicone and oil. The one or more simulated masses are indicative of one or more of: fibrocystic nodes, carcinoma in a milk duct, fibroadenomas, benign mass, giant sarcoma, giant mammary myxoma, or scirrhous carcinoma. The one or more simulated masses are configured to be imaged using ultrasound. The breast and axilla assembly include one or more connectors configured to removably attach the breast and axilla assembly to the patient simulator. The one or more simulated masses are configured to be imaged using ultrasound.

In one general aspect, the present disclosure is directed to a patient simulator. The patient simulator also includes a simulated torso; a breast and axilla assembly connected to the simulated torso, including: an axilla portion; a breast portion, where the breast portion includes an outer breast portion and an inner breast portion; and one or more simulated masses disposed within the inner breast portion or the axilla portion such that the one or more simulated masses are embedded in simulated breast tissue filling the inner breast portion.

In some aspects, implementations may include one or more of the following features. The patient simulator where the one or more simulated masses are palpable by a user during a simulated breast examination. The one or more simulated masses are 5-30 mm wide. The simulated breast tissue is composed of a mixture of silicone and oil. The one or more simulated masses are indicative of one or more of: fibrocystic nodes, carcinoma in a milk duct, fibroadenomas, benign mass, giant sarcoma, giant mammary myxoma, or scirrhous carcinoma. The breast and axilla assembly includes one or more connectors configured to removably attach the breast and axilla assembly to the patient simulator.

In one general aspect, the present disclosure is directed to a method for assembling a patient simulator. The method also includes attaching a breast and axilla assembly to a simulated torso of a patient simulator. The method also includes where the breast and axilla assembly includes: an axilla portion; a breast portion, where the breast portion includes an outer breast portion and an inner breast portion; and one or more simulated masses disposed within the inner breast portion or the axilla portion such that the one or more simulated masses are embedded in simulated breast tissue filling the inner breast portion.

In some aspects, implementations may include one or more of the following features. The method where the one or more simulated masses are palpable by a user during a simulated breast examination. The one or more simulated masses are 5-30 mm wide. The simulated breast tissue is composed of a mixture of silicone and oil. The one or more simulated masses are indicative of one or more of: fibrocystic nodes, carcinoma in a milk duct, fibroadenomas, benign mass, giant sarcoma, giant mammary myxoma, or scirrhous carcinoma. The one or more simulated masses are configured to be imaged using ultrasound. The method may include: removing the breast and axilla assembly from the simulated torso; and attaching a second breast and axilla assembly with a second one or more simulated masses different from the one or more simulated masses.

Although illustrative aspects have been shown and described, a wide range of modification, change, and substitution is contemplated in the foregoing disclosure and in some instances, some features of the present disclosure may be employed without a corresponding use of the other features. It is understood that such variations may be made in the foregoing without departing from the scope of the aspects. Accordingly, it is appropriate that the appended claims be construed broadly and in a manner consistent with the scope of the present disclosure.

1. A shoulder assembly for a patient simulator, the shoulder assembly configured to control positioning and orientation of a simulated arm of a patient simulator, comprising:
a first portion connected to a simulated torso of the patient simulator; and
a second portion,
wherein the first portion includes a mechanical joint,
wherein the mechanical joint is configured to rotate around a first axis and a second axis.

2. The shoulder assembly of claim 1, wherein the shoulder assembly is actuatable at the mechanical joint to allow the simulated arm of the patient simulator to be configured for examination by a user.

3. The shoulder assembly of claim 2, wherein the examination is a breast or axilla examination.

4. The shoulder assembly of claim 1, further comprising:
an outer sleeve surrounding at least the first portion and connected to the simulated torso.

5. The shoulder assembly of claim 1, wherein the first axis and the second axis are perpendicular to each other.

6. The shoulder assembly of claim 1, wherein the shoulder assembly is sized for an adult patient simulator.

7. The shoulder assembly of claim 1, wherein the shoulder assembly is sized for a child patient simulator.

8. A patient simulator, comprising:
a simulated torso; and
a first simulated arm, wherein the first simulated arm includes a shoulder assembly configured to control positioning and orientation of the first simulated arm,
wherein the shoulder assembly includes:
a first portion connected to a simulated torso of the patient simulator; and
a second portion connected to the first portion,
wherein the first portion includes a mechanical joint,
wherein the mechanical joint is configured to rotate around a first axis and a second axis.

9. The patient simulator of claim 8, wherein the shoulder assembly is actuatable at the mechanical joint to allow the first simulated arm of the patient simulator to be configured for examination by a user.

10. The patient simulator of claim 9, wherein the examination is a breast or axilla examination.

11. The patient simulator of claim 8, further comprising:
an outer sleeve surrounding at least the first portion and connected to the simulated torso.

12. The patient simulator of claim 8, wherein the first axis and the second axis are perpendicular to each other.

13. The patient simulator of claim 8, wherein the shoulder assembly is sized for an adult patient simulator.

14. The patient simulator of claim 8, further comprising:
a second simulated arm, wherein the second simulated arm includes a second shoulder assembly configured to control positioning and orientation of the second simulated arm,
wherein the second shoulder assembly includes:
a third portion connected to the simulated torso of the patient simulator on a side opposite the first portion; and
a fourth portion,
wherein the third portion includes a second mechanical joint,
wherein the mechanical joint is configured to rotate around a third axis and a fourth axis, and
wherein the first simulated arm and second simulated arm are configured for bilateral articulation.

15. A breast and axilla assembly for a patient simulator, comprising:
an axilla portion;
a breast portion, wherein the breast portion includes an outer breast portion and an inner breast portion; and
one or more simulated masses disposed within the inner breast portion or the axilla portion such that the one or more simulated masses are embedded in simulated breast tissue filling the inner breast portion.

16. The breast and axilla assembly of claim 15, wherein the one or more simulated masses are palpable by a user during a simulated breast examination.

17. The breast and axilla assembly of claim 15, wherein the one or more simulated masses are 5-30 mm wide.

18. The breast and axilla assembly of claim 15, wherein the simulated breast tissue is composed of a mixture of silicone and oil.

19. The breast and axilla assembly of claim 15, wherein the one or more simulated masses are indicative of one or more of:
fibrocystic nodes,
carcinoma in a milk duct,
fibroadenomas,
benign mass,
giant sarcoma,
giant mammary myxoma, or
scirrhous carcinoma.

20. The breast and axilla assembly of claim 15, wherein the one or more simulated masses are configured to be imaged using ultrasound.
